(19) United States
(12) Patent Application Publication
(10) Pub. No.: US 2004/0064389 A1
(43) Pub. Date: Apr. 1, 2004

(54) Electronic invoice processing system with budgeting capability

(76) Inventors: Michael Patrick Force, (US); Lisa Christine Batur, (US); Julie Violet Pierce, (US)

Correspondence Address: Grossman Tucker Perreault & Pfleger, PLLC, 55 South Commercial Street, Manchester, NH, 03101, US

(21) Appl. No.: 10/260,935

(22) Filed: Sep. 30, 2002

(51) Int. Cl. G06F 17/60

(52) U.S. Cl. 705/34

(57) ABSTRACT

A budget software application is provided to aid corporate client systems in analysis of electronic invoices from law firm systems by: prompting at least one of the corporate client systems to provide invoice identifying information to properly identify an invoice from one of the law firm systems, the invoice identifying information including at least an identified billing matter; prompting at least one of the corporate client systems to define a budgeted item; prompting at least one of the corporate client systems to define a budgeted amount for the budgeted item; and storing the budgeted item and the budgeted amount. A rules engine that permits creation of rules for such budgeted items is also provided. Machine readable medium and related electronic invoice processing systems having such media for performing such functions is also provided.

### FIELD OF THE INVENTION

The present invention relates generally to an internet-based electronic invoice processing system, and in particular to such a system having a rules engine capable of budget creation, budget approval, and invoice analysis in view of budgeted values.

### BACKGROUND OF THE INVENTION

Various internet-based electronic invoice processing systems are known in the art whereby a vendor can electronically create and present a bill to a customer for review. Such systems may also incorporate electronic payment features. Such electronic systems have the advantage of displacing traditional paper-based billing and payment methods. As such, efficiencies can be realized for both a vendor and customer by avoiding associated manual work created by such traditional paper-based billing and processing methods.

When the vendor and customer are businesses conducting business-to-business transactions, for example, when the vendor is a law firm and the customer is a client corporation, complex billing rules are often negotiated and must be adhered to by the law firm. For instance, these rules may relate to a variety of matters including timekeeper rates and unit rates per various expense categories. The law firm should implement systems for generating its bills in compliance with the rules and the corporate client customer typically finds it useful to check each bill to assure the law firm has complied.

In prior art electronic invoice processing systems, a rules engine may not typically be provided, or if it is provided, it typically has limited functionality and flexibility. A rules engine is a software application that applies particular rules to all or selected invoices to aid a customer in invoice analysis and adjustment. Such rules engines are not provided with the functionality that enable customers to create budgets, update budgets, and analyze invoices in view rules based on such budgets. Accordingly, there is a need in the art for a flexible rules engine with enhanced features capable of budget creation and application of created budgets during invoice analysis.

### BRIEF SUMMARY OF THE INVENTION

A method of creating a budget to aid corporate client systems in analysis of electronic invoices from law firm systems, the method consistent with the invention includes the steps of: prompting at least one of the corporate client systems to provide invoice identifying information to properly identify an invoice from one of the law firm systems, the invoice identifying information comprising at least an identified billing matter; prompting the at least one of the corporate client systems to define a budgeted item; prompting the at least one of the corporate client systems to define a budgeted amount for the budgeted item; and storing the budgeted item and the budgeted amount.

Another method of creating a budget to aid corporate client systems in analysis of electronic invoices from law firm systems consistent with the invention includes the steps of: prompting at least one of the law firm systems to provide invoice identifying information to properly identify an invoice from the at least one of the law firm systems, the invoice identifying information including at least an identified billing matter and one of the corporate clients to whom the invoice would be directed; prompting the at least one of the law firm systems to define a budgeted item; prompting the at least one of the law firm systems to define a budgeted amount for the budgeted item; and storing the budgeted item and the budgeted amount.

Another method of creating a budget rule to aid in electronic invoice analysis consistent with the invention includes the steps of: prompting a user to provide invoice identifying information for an electronic invoice comprising at least an identified billing matter; prompting the user to select a budgeted item; prompting the user to define a budgeted amount for the budgeted item; prompting the user to define a trigger value associated with the budgeted item; and prompting the user to select an action to take if the trigger value is greater than the budgeted amount for the budgeted item.

A machine readable medium consistent with the invention whose contents cause a computer server system to perform a method of creating a budget to aid corporate client systems in analysis of electronic invoices from law firm systems including the steps of: prompting at least one of the corporate client systems to provide invoice identifying information to properly identify an invoice from one of the law firm systems, the invoice identifying information comprising at least an identified billing matter; prompting the at least one of the corporate client systems to define a budgeted item; prompting the at least one of the corporate client systems to define a budgeted amount for the budgeted item; and storing the budgeted item and the budgeted amount.

Another machine readable medium consistent with the invention whose contents cause a computer server system to perform a method of creating a budget to aid corporate client systems in analysis of electronic invoices from law firm systems includes the steps of: prompting at least one of the law firm systems to provide invoice identifying information to properly identify an invoice from the at least one of the law firm systems, the invoice identifying information comprising at least an identified billing matter and one of the corporate clients to whom the invoice would be directed; prompting the at least one of the law firm systems to define a budgeted item; prompting the at least one of the law firm systems to define a budgeted amount for the budgeted item; and storing the budgeted item and the budgeted amount.

Another machine readable medium consistent with the invention whose contents cause a computer server system to perform a method of creating a budget rule to aid in electronic invoice analysis includes the steps of: prompting a user to provide invoice identifying information for an electronic invoice comprising at least an identified billing matter; prompting the user to select a budgeted item; prompting the user to define a budgeted amount for the budgeted item; prompting the user to define a trigger value associated with the budgeted item; and prompting the user to select an action to take if the trigger value is greater than the budgeted amount for the budgeted item.

An electronic invoice processing system consistent with the invention includes: a plurality of law firm systems; a plurality of corporate client systems; and a data center configured to receive an electronic invoice from at least one of the law firm systems, the data center comprising a data center computer server and a machine readable medium whose contents cause the data center computer server to perform a method of creating a budget to aid the plurality of corporate client systems in analysis of electronic invoices from the plurality of law firm systems, the method including the steps of: prompting at least one of the plurality of corporate clients to provide invoice identifying information to properly identify an invoice from one of the plurality of law firm systems, the invoice identifying information including at least an identified billing matter; prompting the at least one of the plurality of corporate clients to define a budgeted item; prompting the at least one of the plurality of corporate clients to define a budgeted amount for the budgeted item; and storing the budgeted item and the budgeted amount.

Another electronic invoice processing system consistent with the invention includes: a plurality of law firm systems; a plurality of corporate client systems; and a data center configured to receive an electronic invoice from at least one of the plurality of law firm systems, the data center comprising a data center computer server and a machine readable medium whose contents cause the data center computer server to perform a method of creating a budget to aid the plurality of corporate clients in analysis of electronic invoices from the plurality of law firm systems, the method including the steps of: prompting at least one of the plurality of law firm systems to provide invoice identifying information to properly identify an invoice from the at least one of the plurality of law firm systems, the invoice identifying information comprising at least an identified billing matter and one of the corporate clients to whom the invoice would be directed; prompting the at least one of the plurality of law firm systems to define a budgeted item; prompting the at least one of the plurality of law firm systems to define a budgeted amount for the budgeted item; and storing the budgeted item and the budgeted amount.

Another electronic invoice processing system consistent with the invention includes: a plurality of vendor systems; a plurality of customer systems; a data center configured to receive an electronic invoice from at least one of the plurality of vendor systems, the data center comprising a data center computer server and a machine readable medium whose contents cause the data center computer server to perform a method of creating a budget rule to aid in electronic invoice analysis comprising the steps of: prompting at least one of the customer systems to provide invoice identifying information for an electronic invoice comprising at least an identified billing matter; prompting the at least one of the customer systems to select a budgeted item; prompting the at least one of the customer systems to define a budgeted amount for the budgeted item; prompting the at least one of the customer systems to define a trigger value associated with the budgeted item; and prompting the at least one of the customer systems to select an action to take if the trigger value is greater than the budgeted amount for the budgeted item.

### BRIEF DESCRIPTION OF THE DRAWINGS

Advantages of the present invention will be apparent from the following detailed description of exemplary embodiments thereof, which description should be considered in conjunction with the accompanying drawings, in which:

FIG. 1 is a block diagram of an electronic invoice processing system consistent with the invention;

FIG. 2 is a flow chart of an exemplary process for creating a budgeted amount for a select matter;

FIG. 3 is a flow chart of an exemplary process for creating a specific budget for various line items of a matter category;

FIG. 4 is an exemplary table consistent with the invention for referencing budget data created by the processes of FIG. 2 or FIG. 3;

FIG. 5 is an exemplary screen display providing a user-friendly interface to track billed amounts versus budgeted amounts;

FIG. 6 is a flow chart of an exemplary process for creating a rule associated with a budget amount;

FIG. 7 is an exemplary table consistent with the invention for referencing rule data created by the rule process of FIG. 6; and

FIG. 8 is a flow chart of an exemplary process for applying the budget rule created by the budget rule creation process of FIG. 6.

### DETAILED DESCRIPTION

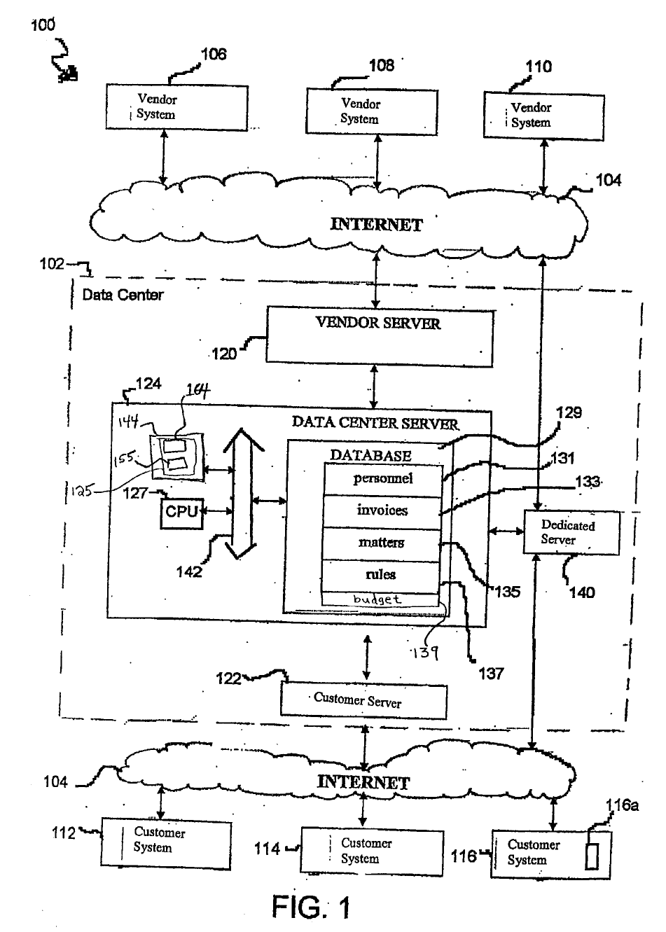

FIG. 1 illustrates a web-based electronic invoice processing system 100 consistent with the invention. In general, the system 100 includes a data center 102 coupled via the internet 104 to various vendor systems 106, 108, 110 and customer systems 112, 114, 116. The data center 102 serves as a centralized repository for storing, managing, and processing data related to invoice generation, analysis, and payment as further detailed herein. The data center 102 includes a vendor server 120, a customer server 122, a data center server 124, and a dedicated server 140. In one of many embodiments, the system 100 may be used as a legal e-billing system enabling a plurality of law firms (vendor systems) and their client corporations (customer systems) to engage in electronic invoice processing and payment.

In general, the system 100 permits vendor systems 106, 108, 110 to present invoices, in electronic form, to various customer systems 112, 114, 116, and allows customer systems 112, 114, 116 to automate a number of invoice review and processing operations as detailed further herein.

The vendor systems 106, 108, 110 and customer systems 112, 114, 116 represent parties that participate in the system 100. Each party may have one or more computer workstations having appropriate hardware and browser software, e.g., Netscape Navigator™ or Microsoft Internet Explorer™, and/or direct real-time Transmission Control Protocol/Internet Protocol (TCP/IP), for permitting human users to send and receive data to the data center 102 and to control various operations of the data center 102 in real time and/or batch type transactions. To provide secure transmissions over the internet 104, the browser software should preferably have a minimum 128-bit encryption capability. As such, all files, e.g., invoice files, matter files, and timekeeper files, are encrypted when they are sent over the internet 104 to an associated server 120, 122.

Each vendor system 106, 108, 110 or customer system 112, 114, 116 may also have one or more associated servers, e.g., server 116a for customer system 116, that run associated applications. For instance, each vendor system 106, 108, 110 may have any one of a plurality of time and billing software systems, and each customer system 112, 114, 116 may have any one of a plurality of matter management systems or accounts payable systems.

In order to communicate and integrate with such outside systems of each vendor system and customer system, the system 100 may be further equipped with a dedicated server 140 that is configured to transfer and receive data to and from associated servers of vendors or customers using a predetermined communication protocol. For example, such a server 140 may be a File Transfer Protocol (FTP) server that can exchange files using FTP protocol to an associated server of any vendor systems 106, 108, 110 or customer systems 112, 114, 116.

For example, server 116a of customer system 116 may transfer matter management data from its matter management system to the server 140. The data center server 124 may then later accept such data for use in any of its processes. The data center server 124 may also transfer data, e.g., invoice data, to the server 140 so that the server 140 can later communicate such data to the accounts payable system of customer system 116 via server 116a. As such, the server 140 provides a way to integrate the data center 102 with disparate systems of any vendor or customer.

The vendor server 120 and customer server 122 are illustrated and described herein as separate server software applications operated on separate hardware systems for clarity of description. Those skilled in the art will recognize however, that such functionality for each could be combined on one server application or in multiple server applications operating on a single hardware system. Access to the servers 120, 122 by the vendor systems 106, 108, 110 and customer systems 112, 114, 116 may be through a variety of communication channels over the internet 104 such as point-to-point leased line/frame relay, public internet via an internet service provider, or a virtual private network (VPN) to name a few.

In addition, data transfers between vendor systems 106, 108, 110 and customer systems 112, 114, 116 to the data center server 124 may use a predetermined communication protocol as well so that the data content of the files is recognized by the data center server 124 and the “associated application” at the vendor systems 106, 108, 110 or customer systems 112, 114, 116. For instance, in transferring invoice data from a vendor system 106, 108, 110 to the data center 102 a standard format such as the LEDES™ electronic invoice standard coordinated by PriceWaterhouseCoopers may be utilized.

The vendor server 120 is a software application that provides services to other client software applications in a client/server relationship. In one instance, the vendor server 120 provides services to the vendor systems 106, 108, 110. In another instance, the vendor server 120 acts as a client in making requests to the data center server 124 which fulfills such requests. For instance, the data center server 124 may provide view matter, review invoices, and submit invoice transactions to the vendor server 120. The vendor server 120 builds a Hypertext Markup Language (HTML) or other graphical user interface (GUI) document in accordance therewith. A GUI document is then provided to the vendor system 106, 108, 110 which displays various GUI documents. Such GUI documents enable the user to perform a variety of functions such as viewing matters assigned to them, reviewing invoices, and submiting invoices and timekeepers.

Similar to the vendor server 120, the customer server 122 is a software application that provides services to other client software applications in a client/server relationship. In one instance, the customer server 122 provides services to the customer systems 112, 114, 116. In another instance, the customer server 122 acts as a client in making requests to the data center server 124 which fulfills such requests. The customer server 122 builds an HTML or other GUI document in accordance with such request. A GUI document is then provided to the customer system 112, 114, 116 which displays such documents. Such GUI documents enable a customer user to perform a variety of functions such as reviewing invoices, creating budgets, and creating rules that may refer to such budgets.

The data center server 124 of the data center 102 includes a processor 127 which operates data center server applications 125 that performs the main processing operations for the system 100. The data base server 124 also includes an extensive database 129 that contains aggregations of data records. Such data records relate to vendor systems 106, 108, 110, customer systems 112, 114, 116, and associated information. The database 129 is a relational database such as a DB2 database from IBM Corporation that can manage the large volumes of data to be stored and processed by the data center server 124. A standard user and application program interface to such a relational database is structured query language (SQL).

For clarity of description, some of the related aggregated data categories in the relational database are described herein as “data modules.” Some of the data modules include a personnel data module 131, an invoices data module 133, a matters data module 135, a rules data module 137, and a budget data module 139 to name several. In general, the personnel data module contains information about personnel of the customer systems 112, 114, 116 who are able to act upon invoices. The invoices data module 133 contains invoice related data submitted by the various vendors. The matters data module 135 contains basic information to identify and describe various matters. The rules data module 137 contains data relating to any rules defined by any customer 112, 114, 116. Finally, the budget data module 139 contains data created when a budget was defined as further detailed herein. Each of these data modules may be implemented in one or more related database tables.

The rules engine 164 is one of the software applications 125 that is stored on a machine readable media 144 of the data center server 124. This rules engine 164 performs transactions to enable a user of the customer system 112, 114, 116 to create specific rules and store relevant data for such rules in the rules data module 137 that may then be later applied to particular customer-vendor relationships. For instance, the data center server applications 125 including the rules engine 164 are software routines that may be stored on any variety of machine readable media 144 for execution by the CPU 127. The processor 127 of the data center server 124 can be any type of processor capable of providing the speed and functionality required by embodiments of the invention. For example, the processor could be a processor from the Pentium® family of processors made by Intel Corporation.

The machine-readable media 144 can be any type of media capable of storing instructions adapted to be executed by the processor 127. Some examples of such media include, but are not limited to, system RAM, read only memory (ROM), programmable ROM, magnetic disk (e.g., floppy disk and hard disk drive), optical disk (e.g., CD/DVD ROM), and any other device that can store digital information. As used herein, the phrase “adapted to be executed by a processor” is meant to encompass instructions stored in compressed and/or encrypted format, as well as instructions that have to be compiled or installed by an installer before being executed by the processor. The processor 127 and machine-readable medium 144 may be part of various components of the data center 102 and data center server 124 where various combinations of machine-readable media may store combinations of the rules engine software which are accessible by the processor through various controllers.

Advantageously, the data center applications 125 also include a budget application 155 which enables either vendor systems 106, 108, 110 or customer systems 112, 114, 116 to create a budget. Once a budget is created, the budget application 155 also provides users with a means to track various budgeted amounts versus billed amounts and/or approved amounts. The rules engine 164 also provides users with a means to create rules and select defined to take place if the defined rule condition relating to a budgeted matter is violated.

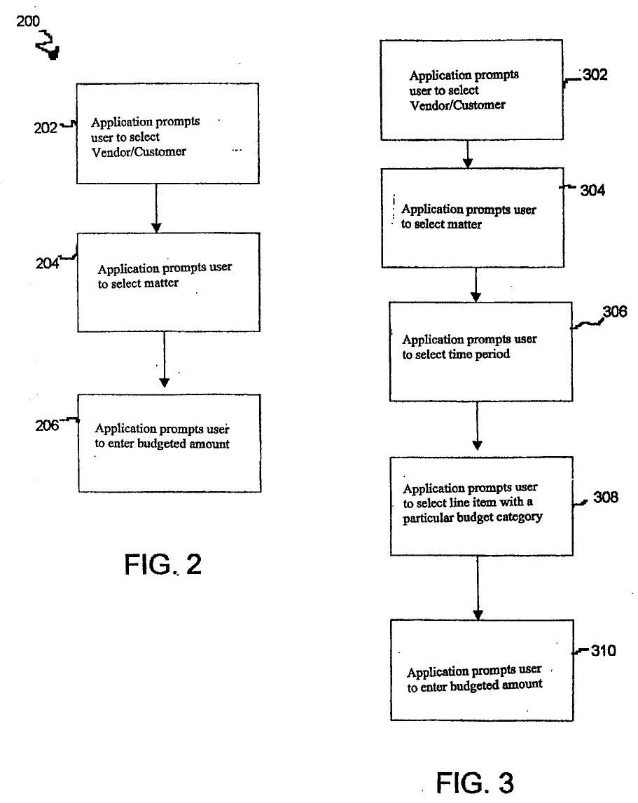

Turning to FIG. 2, an exemplary flow chart 200 illustrating the general process of budget creation for a select matter is illustrated. First, the budget application 155 prompts a user of the vendor system 106, 108, 110 or the customer system 112, 114, 116 to select a vendor/customer to which the budget applies in step 202. Next, the budget application 155 prompts the user to select a particular matter for budgeting 204. Finally, the budget application 155 prompts the user to enter a budgeted amount in step 206 for the matter identified in step 204.

Turning to FIG. 3, a more detailed flow chart 300 illustrating creation of a more specific line item budget than the general matter budget of FIG. 2 is illustrated. Similarly, the budget application 155 prompts a user of the vendor system 106, 108, 110 or the customer system 112, 114, 116 to select a vendor/customer to which the budget applies in step 302. Next, the budget application 155 prompts the user to select a particular matter for budgeting 304. Next, the budget application prompts the user to select a particular time period by entering a budget start date and end date 306.

Next, the budget application prompts the user to select a line item within a particular budget category 308. For instance, if the vendor is a law firm and the customer is a corporate client of the law firm, the categories may be for a litigation matter, a bankruptcy matter, a counseling matter, or some other similar category depending on the situation. Within each category, specific items may be further identified. For instance, a bankruptcy matter may have a plurality of line items including case administration, claims administration and objections, and Bankruptcy related advice, etc. Finally, the budget application prompts a user to enter a budgeted for each selected line item from the previous step 308. As such, a more detailed budget can be created.

Typically, a user of the customer system 112, 114, 116 creates the budgeted amount. However, a budget application 155 consistent with the invention also permits a user of the vendor system 106, 108, 110 to create a budget consistent with the processes of FIGS. 2 and 3. If created by a vendor user, the created budget is then submitted to the appropriate customer for approval. This provides the vendors a mechanism to create budgets that they may not otherwise enjoy.

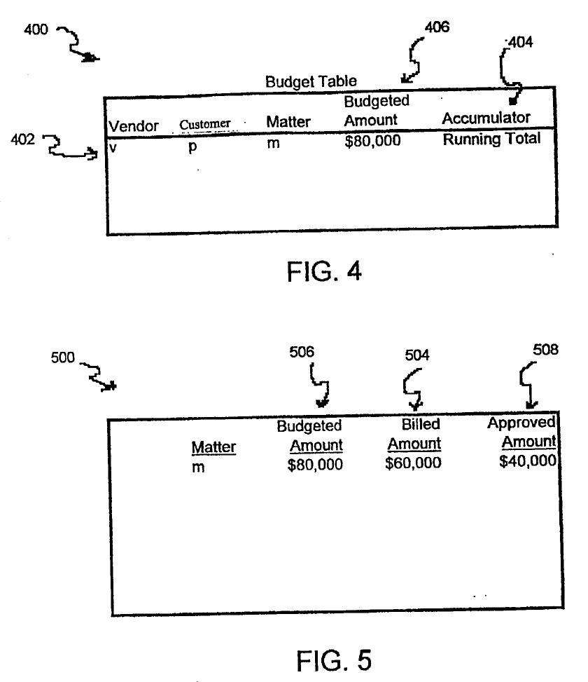

Turning to FIG. 4, once a general or more specific budget is created, the budget application 155 directs storage of related budget data on an applicable machine readable media 144 and directs appropriate data base tables 400 of the data base 129 to be updated. For instance, the exemplary table 400 of FIG. 4 may be part of the budget data module 139. The necessary data fields updated in the table 400 depend on the particulars of the created budget.

For a simpler budget relating to a total budgeted dollar amount for a selected matter, the necessary data would contain a code v for the vendor, a code p for the customer, a code m for the matter, and the budgeted amount, e.g., $80,000, in the table 400. Finally, an accumulator column would be structured to keep track of invoice amounts for this matter. When an invoice is received by a particular customer, the budget application 155 would instruct the related invoice data to be updated in the invoice data module 133 of the data base 129. As such, the budget application 155 can cross check pertinent invoice data referenced in the invoice data module 133 (in the example of FIG. 4 such pertinent data includes vendor code v, customer code p, and matter code m) against data from the budget data module to see if a particular budget applies to the invoice. If it does, the budget application 155 would store the first invoice total in the accumulator column 404 of the table 400 and subsequent invoices would be added to the prior invoice in order to keep a running total of the total amount billed to date on the selected matter m.

Once a budget for a particular matter is created and referenced in the database table 400, future updates to such budget may “update” the information stored in a particular row rather than create a new row for each update. Budget information may also be deleted as necessary.

Turning to FIG. 5, the budget application 155 allows a user of the customer system 112, 114, 116 to access a GUI 500 for easily tracking budgeted amounts versus billed amounts. In creating this GUI 500, the budget application 155 pulls information from the budget table 400. For instance, the budget application 155 pulls information from the budgeted amount column 406 to indicate the total budgeted amount, e.g., $80,000, and also pulls information from the accumulator column 404 to indicate the Billed Amount to date, e.g., $60,000. Another column 508 may also indicate the approved amount on the select matter m to date. The budget application 155 may pull data for this column from a separate table where such value is stored and updated. As such, the budget application 155 provides a concise GUI to a user for a quick and reliable way to track invoices against budgeted amounts.

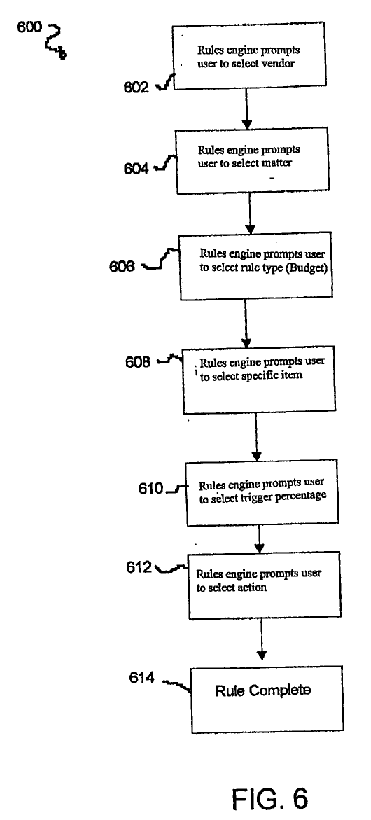

In addition to tracking invoices against budgeted amounts, the rules engine 164, which is one of the software applications 125 of the data center server 124, provides queries to a user of the customer systems 112, 114, 116 that enable such a user to create rules for taking action in case of a violation of a budgeted amount. How the rules engine prompts a user to create such rules, how the rules engine stores rules data entered by such users, and how the rules engine applies such rules is addressed below with reference to FIGS. 6-8 respectively.

Turning to FIG. 6, a flow chart of an exemplary process 600 for creating a rule associated with a budgeted amount is illustrated. The rules engine 164 prompts a user of a customer system 112, 114, 116 to select a vendor 602 and then a matter number 604 to which the rule will apply. The rules engine 164 then prompts the user to select which “type” of rule to create 606. If the user selects a budget type of rule, the rules engine then prompts the user to select from a specific item related to the budget rule type. For instance, this may be invoice total, fee total, expense total etc. The rules engine 164 then prompts the user to select a trigger value 610. The trigger value may advantageously be a percentage value (from 1-100) of the budget amount as previously created from the budget creation process of FIG. 2 or FIG. 3. The rules engine then prompts the user to select an action to take 612, e.g., a flag action or an auto reject action, if such a rule is later violated. Finally, the pertinent budget rule is then complete 614.

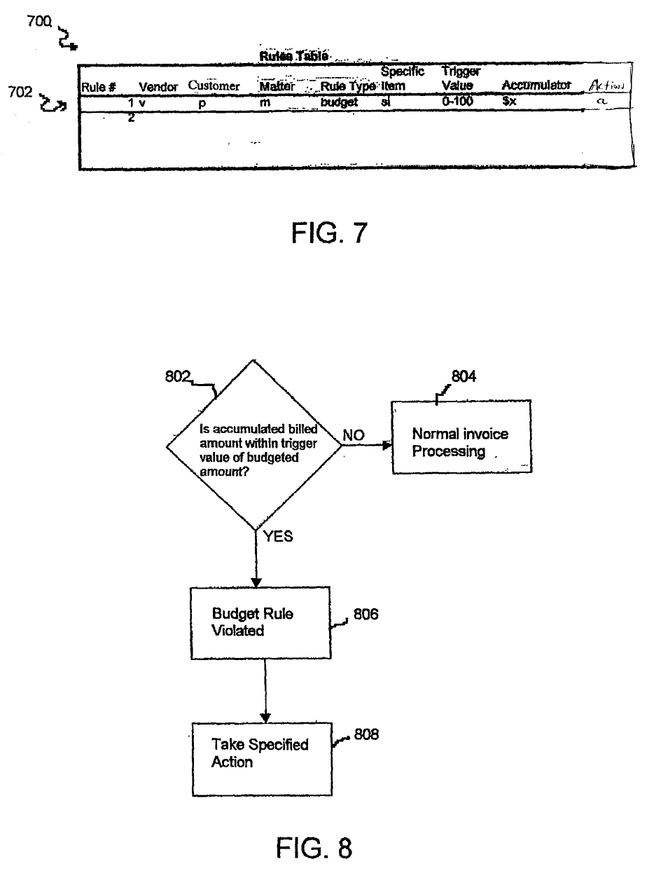

Once the budget rule is complete, the rules engine 164 then inserts associated budget rule data into a pertinent table of the data base 129. Such an exemplary table 700 is illustrated in FIG. 7. The simplified table 700 includes field names such as vendor, customer, matter, rule type (budget rule type in this instance), specific item to budget, trigger value, and action. The first row 702 of data includes information related to the recently formed budget rule according to the process of FIG. 6. For example, a particular vendor value v, customer value p, and matter number m is inserted into the table 700. The rule type in this instance is a budget rule. The budget may be for an invoice total or a more specific line item of a particular category. The pertinent field names or columns in the table 700 should vary with the specifics chosen in the particular budget rule.

The trigger value is a percentage of the budgeted amount. The trigger value can be any value between 1 and 100. For instance, a customer could create a budget rule asking to be warned (specified action) if the specific item in the budgeted amount reaches 80% of the budgeted total. Finally, the last specified column indicates which action to take in case the budgeted rule condition is violated.

Turning to FIG. 8, a flow chart 800 of an exemplary process for applying the budget rule created by the budget rule creation process of FIG. 6 is illustrated. The rules engine 164 determines if the accumulated billed amount is over the earlier defined trigger value. The rules engine 164 may accomplish this in a variety of ways known by those skilled in the art. One way is by comparing appropriate fields of the accumulated invoice total (e.g., the accumulated total from table 400) with the product of the trigger value percentage (e.g., from table 700) and the budgeted amount (from table 400).

If no rules violation is detected, normal invoice processing steps would continue 804. If a budget rule violation was detected and the rule was violated 806, a specified action would then be taken 808. The specified action 808 could be to issue a warning flag to all invoice reviewers or to automatically reject such invoice.

The embodiments that have been described herein, however, are but some of the several which utilize this invention and are set forth here by way of illustration but not of limitation. It is obvious that many other embodiments, which will be readily apparent to those skilled in the art, may be made without departing materially from the spirit and scope of the invention as defined in the appended claims.

What is claimed is:

1. A method of creating a budget to aid corporate client systems in analysis of electronic invoices from law firm systems, said method comprising the steps of:
prompting at least one of said corporate client systems to provide invoice identifying information to properly identify an invoice from one of said law firm systems, said invoice identifying information comprising at least an identified billing matter;
prompting said at least one of said corporate client systems to define a budgeted item;
prompting said at least one of said corporate client systems to define a budgeted amount for said budgeted item; and
storing said budgeted item and said budgeted amount.

2. The method of claim 1, wherein said storing step further comprises storing said invoice identifying information.

3. The method of claim 1, further comprising
receiving a first electronic invoice submitted by said at least one of said law firm systems;
identifying said first electronic invoice as containing a first item amount for said budgeted item; and
comparing said first item amount with said budgeted amount.

4. The method of claim 3, further comprising:
receiving a second electronic invoice submitted by said at least one of said law firm systems;
identifying said second electronic invoice as containing a second item amount for said budgeted item;
summing said second item amount with said first item amount total to obtain an accrued item amount; and
comparing said accrued item amount with said budgeted amount.

5. The method of claim 1, wherein said budgeted item is said identified billing matter.

6. The method of claim 1, wherein said budgeted item is a line item of said identified billing matter.

7. A method of creating a budget to aid corporate client systems in analysis of electronic invoices from law firm systems, said method comprising the steps of:
prompting at least one of said law firm systems to provide invoice identifying information to properly identify an invoice from said at least one of said law firm systems, said invoice identifying information comprising at least an identified billing matter and one of said corporate clients to whom said invoice would be directed;
prompting said at least one of said law firm systems to define a budgeted item;
prompting said at least one of said law firm systems to define a budgeted amount for said budgeted item; and
storing said budgeted item and said budgeted amount.

8. The method of claim 7, wherein said budgeted amount is subject to approval by said one of said corporate client systems to whom said invoice is directed.

9. A method of creating a budget rule to aid in electronic invoice analysis comprising the steps of:
prompting a user to provide invoice identifying information for an electronic invoice comprising at least an identified billing matter;
prompting said user to select a budgeted item;
prompting said user to define a budgeted amount for said budgeted item;
prompting said user to define a trigger value associated with said budgeted item; and
prompting said user to select an action to take if said trigger value is greater than said budgeted amount for said budgeted item.

10. The method of claim 9, wherein said trigger value is determined by a trigger percentage multiplied by said budgeted amount.

11. The method of claim 9, further comprising the step of storing said invoice identifying information, said billable item, said budgeted amount, said trigger value, and said action.

12. The method of claim 9, wherein said invoice identifying information further comprises vendor data and customer data.

13. The method of claim 9, wherein said budgeted item is said identified billing matter.

14. The method of claim 9, wherein said budgeted item is a line item of said identified billing matter.

15. The method of claim 9, wherein said action is an auto reject action or a flag action.

16. A machine readable medium whose contents cause a computer server system to perform a method of creating a budget to aid corporate client systems in analysis of electronic invoices from law firm systems, said method comprising the steps of:
prompting at least one of said corporate client systems to provide invoice identifying information to properly identify an invoice from one of said law firm systems, said invoice identifying information comprising at least an identified billing matter;
prompting said at least one of said corporate client systems to define a budgeted item;
prompting said at least one of said corporate client systems to define a budgeted amount for said budgeted item; and
storing said budgeted item and said budgeted amount.

17. The machine readable medium of claim 16, wherein said storing step further comprises storing said invoice identifying information.

18. The machine readable medium of claim 16, wherein said method further comprises:
receiving a first electronic invoice submitted by said at least one of said law firm systems;
identifying said first electronic invoice as containing a first item amount for said budgeted item; and
comparing said first item amount with said budgeted amount.

19. The machine readable medium of claim 18, wherein said method further comprises:
receiving a second electronic invoice submitted by said at least one of said law firm systems;
identifying said second electronic invoice as containing a second item amount for said budgeted item;
summing said second item amount with said first item amount total to obtain an accrued item amount; and
comparing said accrued item amount with said budgeted amount.

20. The machine readable medium of claim 16, wherein said budgeted item is said identified billing matter.

21. The machine readable medium of claim 16, wherein said budgeted item is a line item of said identified billing matter.

22. A machine readable medium whose contents cause a computer server system to perform a method of creating a budget to aid corporate client systems in analysis of electronic invoices from law firm systems, said method comprising the steps of:
prompting at least one of said law firm systems to provide invoice identifying information to properly identify an invoice from said at least one of said law firm systems, said invoice identifying information comprising at least an identified billing matter and one of said corporate clients to whom said invoice would be directed;
prompting said at least one of said law firm systems to define a budgeted item;
prompting said at least one of said law firm systems to define a budgeted amount for said budgeted item; and
storing said budgeted item and said budgeted amount.

23. The machine readable medium of claim 22, wherein said budgeted amount is subject to approval by said one of said corporate client systems to whom said invoice is directed.

24. A machine readable medium whose contents cause a computer server system to perform a method of creating a budget rule to aid in electronic invoice analysis comprising the steps of:
prompting a user to provide invoice identifying information for an electronic invoice comprising at least an identified billing matter;
prompting said user to select a budgeted item;
prompting said user to define a budgeted amount for said budgeted item;
prompting said user to define a trigger value associated with said budgeted item; and
prompting said user to select an action to take if said trigger value is greater than said budgeted amount for said budgeted item.

25. The machine readable medium of claim 24, wherein said trigger value is determined by a trigger percentage multiplied by said budgeted amount.

26. The machine readable medium of claim 24, wherein said method further comprises the step of storing said invoice identifying information, said billable item, said budgeted amount, said trigger value, and said action.

27. The machine readable medium of claim 24, wherein said invoice identifying information further comprises vendor data and customer data.

28. The machine readable medium of claim 24, wherein said budgeted item is said identified billing matter.

29. The machine readable medium of claim 24, wherein said budgeted item is a line item of said identified billing matter.

30. The machine readable medium of claim 24, wherein said action is an auto reject action or a flag action.

31. An electronic invoice processing system comprising:
a plurality of law firm systems;
a plurality of corporate client systems; and
a data center configured to receive an electronic invoice from at least one of said law firm systems, said data center comprising a data center computer server and a machine readable medium whose contents cause said data center computer server to perform a method of creating a budget to aid said plurality of corporate client systems in analysis of electronic invoices from said plurality of law firm systems, said method comprising the steps of:
prompting at least one of said plurality of corporate clients to provide invoice identifying information to properly identify an invoice from one of said plurality of law firm systems, said invoice identifying information comprising at least an identified billing matter;
prompting said at least one of said plurality of corporate clients to define a budgeted item;
prompting said at least one of said plurality of corporate clients to define a budgeted amount for said budgeted item; and
storing said budgeted item and said budgeted amount.

32. The system of claim 31, wherein said storing step further comprises storing said invoice identifying information.

33. The machine system of claim 31, wherein said method further comprises:
receiving a first electronic invoice submitted by said, at least one of said plurality of law firm systems;
identifying said first electronic invoice as containing a first item amount for said budgeted item; and
comparing said first item amount with said budgeted amount.

34. The system of claim 33, wherein said method further comprises:
receiving a second electronic invoice submitted by said at least one of said plurality of law firm systems;
identifying said second electronic invoice as containing a second item amount for said budgeted item;
summing said second item amount with said first item amount total to obtain an accrued item amount; and
comparing said accrued item amount with said budgeted amount.

35. The system of claim 31, wherein said budgeted item is said identified billing matter.

36. The system of claim 31, wherein said budgeted item is a line item of said identified billing matter.

37. An electronic invoice processing system comprising:
a plurality of law firm systems;
a plurality of corporate client systems; and
a data center configured to receive an electronic invoice from at least one of said plurality of law firm systems, said data center comprising a data center computer server and a machine readable medium whose contents cause said data center computer server to perform a method of creating a budget to aid said plurality of corporate clients in analysis of electronic invoices from said plurality of law firm systems, said method comprising the steps of:
prompting at least one of said plurality of law firm systems to provide invoice identifying information to properly identify an invoice from said at least one of said plurality of law firm systems, said invoice identifying information comprising at least an identified billing matter and one of said corporate clients to whom said invoice would be directed;
prompting said at least one of said plurality of law firm systems to define a budgeted item;
prompting said at least one of said plurality of law firm systems to define a budgeted amount for said budgeted item; and
storing said budgeted item and said budgeted amount.

38. The system of claim 37, wherein said budgeted amount is subject to approval by said one of said plurality of corporate clients to whom said invoice is directed.

39. An electronic invoice processing system comprising:
a plurality of vendor systems;
a plurality of customer systems;
a data center configured to receive an electronic invoice from at least one of said plurality of vendor systems, said data center comprising a data center computer server and a machine readable medium whose contents cause said data center computer server to perform a method of creating a budget rule to aid in electronic invoice analysis comprising the steps of:
prompting at least one of said customer systems to provide invoice identifying information for an electronic invoice comprising at least an identified billing matter;
prompting said at least one of said customer systems to select a budgeted item;
prompting said at least one of said customer systems to define a budgeted amount for said budgeted item;
prompting said at least one of said customer systems to define a trigger value associated with said budgeted item; and
prompting said at least one of said customer systems to select an action to take if said trigger value is greater than said budgeted amount for said budgeted item.

40. The system of claim 39, wherein said trigger value is determined by a trigger percentage multiplied by said budgeted amount.

41. The systems of claim 39, wherein said method further comprises the step of storing said invoice identifying information, said billable item, said budgeted amount, said trigger value, and said action.

42. The system of claim 39, wherein said budgeted item is said identified billing matter.

43. system of claim 39, wherein said budgeted item is a line item of said identified billing matter.

44. The system of claim 24, wherein said action is an auto reject action or a flag action.
